(19) United States
(12) Patent Application Publication
(10) Pub. No.: US 2012/0007810 A1
(43) Pub. Date: Jan. 12, 2012

(54) TOUCH-SENSITIVE DISPLAY APPARATUS

(76) Inventor: Chi-Ming Tseng, Taipei (TW)

(21) Appl. No.: 12/833,946

(22) Filed: Jul. 10, 2010

(51) Int. Cl. G06F 3/041

(52) U.S. Cl. 345/173

(57) ABSTRACT

A touch-sensitive display apparatus includes a shell having two protruding platforms at two opposite ends thereof and a receiving cavity located between the two protruding platforms, a display module accommodated in the receiving cavity, a touch device placed on the display module. The touch device includes two opposite end plates placed on the respective protruding platforms, a touch panel and a top film. At least one end plate defines a hole for positioning the protrusion protruded from the corresponding protruding platform. At least one of two opposite ends of the touch panel extends beyond the display module and is located on an inner side of the corresponding protruding platform to be located at the same plane with the corresponding end plate and adjacent to the corresponding end plate to form a gap therebetween. The top film is attached on the conducting layer and end plates.

### BACKGROUND OF THE INVENTION

1. Field of the Invention

The present invention relates to a display apparatus, and particularly to a touch-sensitive display apparatus.

2. The Related Art

Strengthening glass is used when making a touch panel of the touch-sensitive display apparatus so as to improve users' touch feeling. It is often necessary to make several holes in the touch panel for assembling special components such as buttons and receivers. However, if the holes are made through the strengthening glass, the process may become complicated because it requires turnery, grinding, rubbing, polishing and strengthening. As a result, it brings about high cost. On the other hand, the strength of the glass is weaken because of the holes on it, and the display apparatus is easier to be broken when it falls.

### SUMMARY OF THE INVENTION

Accordingly, an object of the present invention is to provide a touch-sensitive display apparatus. The touch-sensitive display apparatus includes a shell having two protruding platforms at two opposite ends thereof and a receiving cavity located between the two protruding platforms, a display module accommodated in the receiving cavity, a touch device placed on the display module. At least one protruding platform has a protrusion. The touch device includes two opposite end plates placed on the respective protruding platforms, a touch panel and a top film. At least one end plate defines a hole for positioning the protrusion of the corresponding protruding platform. At least one of two opposite ends of the touch panel extends beyond the display module and is located on an inner side of the corresponding protruding platform to be located at the same plane with the corresponding end plate and adjacent to the corresponding end plate to form a gap therebetween. The top film is attached on the conducting layer and end plates.

As described above, the hole for accommodating the protrusion is formed on the end plate instead on the touch panel, so the strength of the touch panel is not affected, also, the progress is simply and the cost is cut down sharply. As the gap between the base layer and the end plate is over the protruding platform, a top film can keep flat when it is pressed.

### BRIEF DESCRIPTION OF THE DRAWINGS

The present invention will be apparent to those skilled in the art by reading the following description thereof, with reference to the attached drawings, in which:

FIG. 1 is an assembled, perspective view of a touch-sensitive display apparatus of an embodiment in accordance with the present invention;

FIG. 2 is an exploded, perspective view of the touch-sensitive display apparatus shown in FIG. 1;

FIG. 3 is an assembled, top view of the touch-sensitive display apparatus shown in FIG. 1;

FIG. 4 is a cross-sectional view of the touch-sensitive display apparatus shown in FIG. 1; and

FIG. 5 is a partly enlarged view showing an enlarged A portion of FIG. 4.

### DETAILED DESCRIPTION OF THE EMBODIMENT

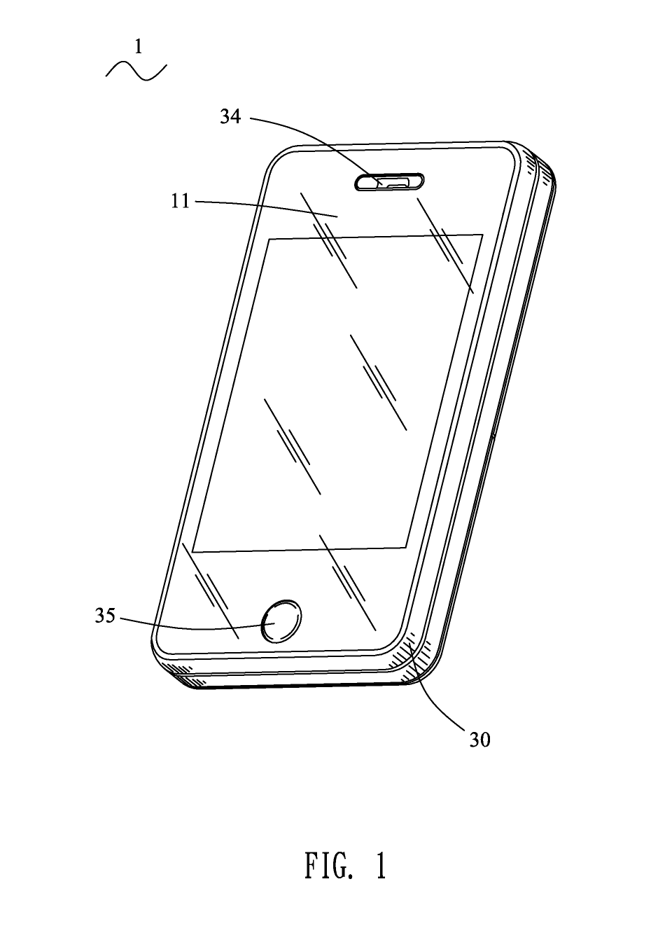

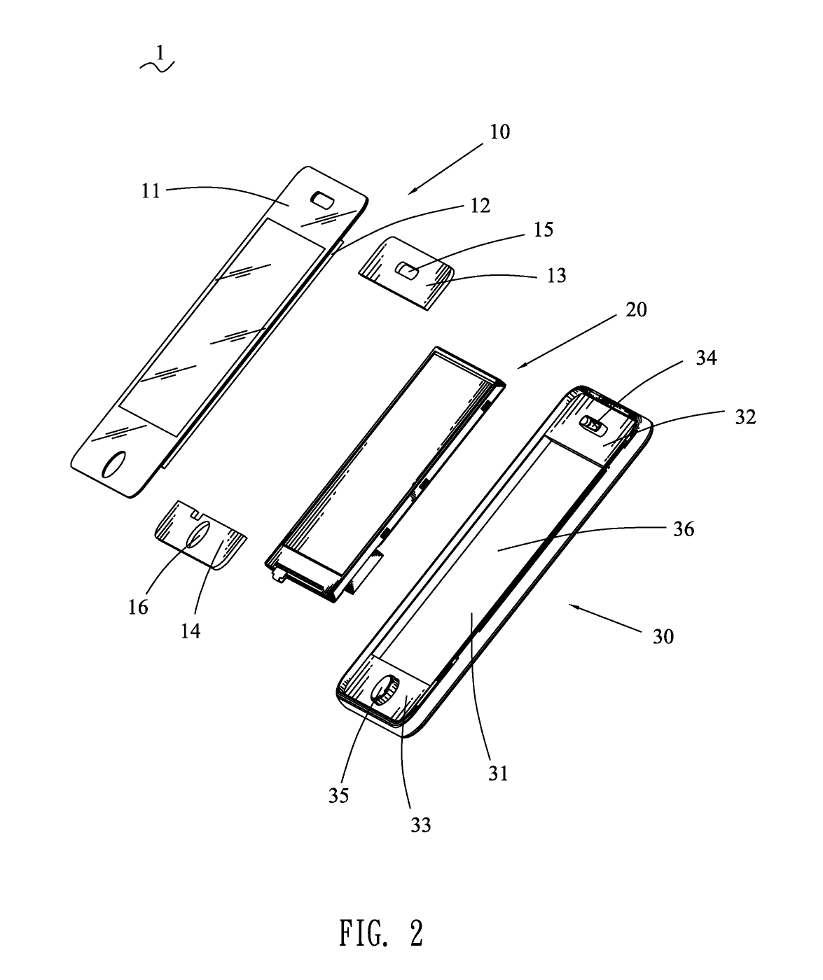

Referring to the drawings in greater detail, and first to FIGS. 1-2, the embodiment of the invention is embodied in a touch-sensitive display apparatus 1. The touch-sensitive display apparatus 1 comprises a shell 30, a display module 20 accommodated in the shell 30, a touch device 10 placed on the display module 20.

Referring to FIGS. 1-2, the shell 30 has a bottom plate 31. The bottom plate 31 has protruding platforms 32, 33 protruded at two opposite ends thereof and forms a receiving cavity 36 located between two protruding platforms 32, 33 for receiving the display module 20 therein. Protrusions 34, 35 are protruded from the protruding platforms 32, 33, respectively. In this embodiment, a first protrusion 34 protruded from a first protruding platform 32 is a receiver, a second protrusion 35 protruded from a second protruding platform 33 is a button.

The display module 20 is accommodated in the receiving cavity 36 with a top thereof substantially flush with that of the protruding platforms 32, 33. A touch device 10 is attached on the display module 20 and the protruding platforms 32, 33. The touch device 10 includes a touch panel 12, two end plats 13, 14, and a top film 11. The end plates 13, 14 are punched to form holes 15, 16 for assembling special components. In this embodiment, a first end plate 13 is punched to form a first hole 15 for receiving the first protrusion 34, a second end plate 14 is punched to form a second hole 16 for receiving the second protrusion 35.

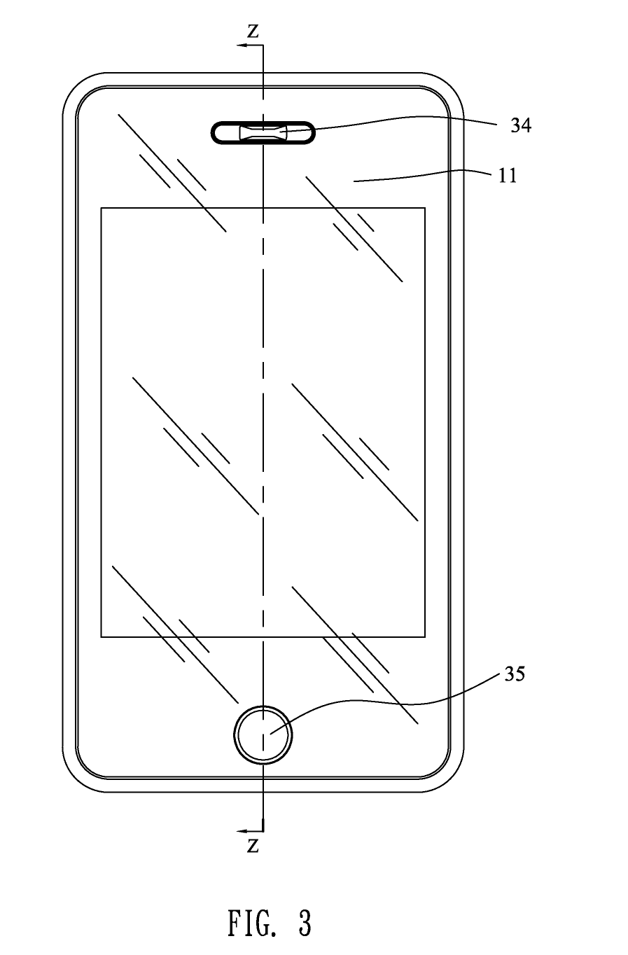

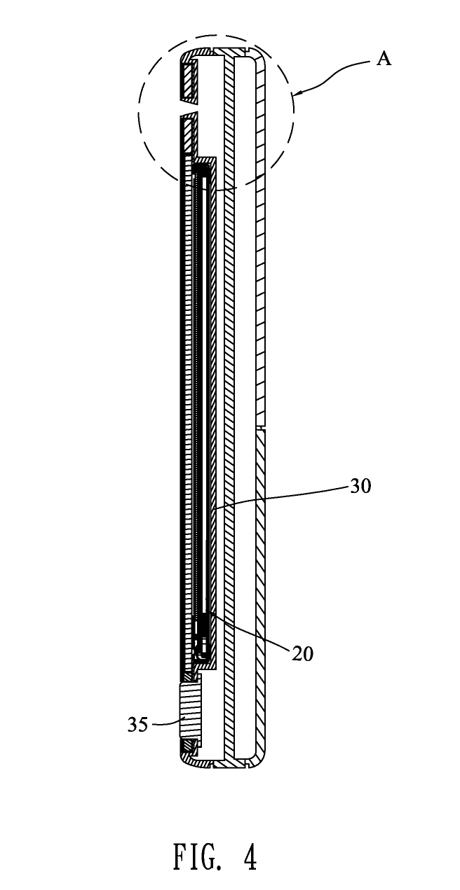

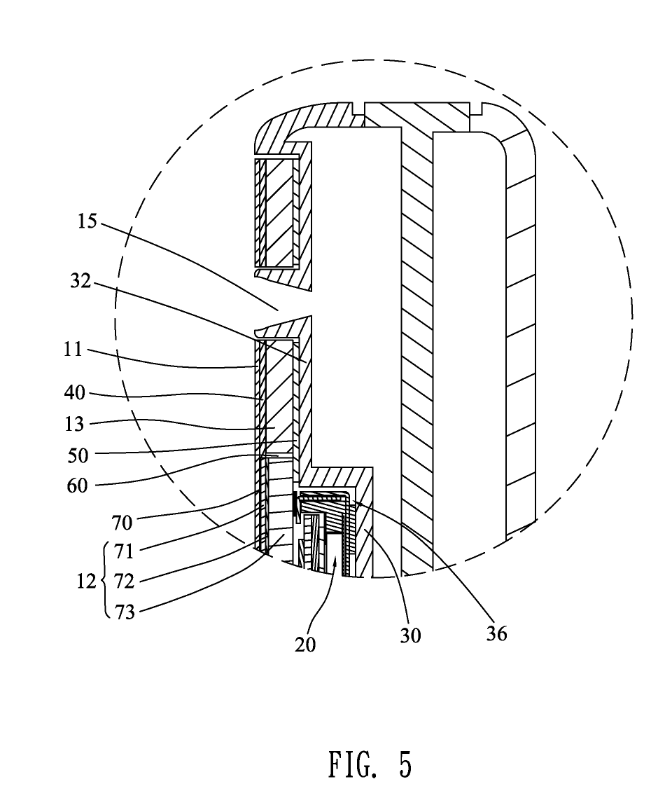

Referring to FIGS. 3-5, the touch panel 12 includes a base layer 73 placed on the display module 20. Both ends of the base layer 73 extend beyond the display module 20 and are located on inner sides of the corresponding protruding platforms 32, 33 to be located at the same plane with the corresponding end plates 13, 14 and adjacent to the corresponding end plates 13, 14 to form gaps 60 therebetween. An insulating layer 72 is attached on the base layer 73, and a conducting layer 71 is attached on the insulating layer 72. In assembly, the two opposite ends of the base layer 73 and the end plate 13, 14 are attached on the protruding platforms 32, 33 by a back adhesive 50, the conducting layer 71 and the top film 11 are connected by an optical adhesive 70, the end plates 13, 14 and the top film 11 are connected by a double-sided adhesive tape 40.

In this embodiment, the conducting layer 71 is made of transparent conductive film. The insulating layer 72 is made of sealing compound. The base layer 73 is made of transparent conductive glass. The end plates 13, 14 are made of plastic.

As described above, the holes 15, 16 for accommodating the protrusions 34, 35 are made on the end plates 13, 14 instead on the touch panel 12, so the strength of the glass of the touch panel 12 is not affected, also, the progress is simply and the cost is cut down sharply. The gaps 60 between the base layer 73 and the end plate 13, 14 is over the protruding platforms 32, 33, as a result, the top film 11 can keep flat when it is pressed.

What is claimed is:

1. A touch-sensitive display apparatus, comprising:
a shell having two protruding platforms at two opposite ends thereof and a receiving cavity located between the two protruding platforms, at least one protruding platform having a protrusion;
a display module accommodated in the receiving cavity; and
a touch device comprising
two opposite end plates placed on the respective protruding platforms, at least one end plate defining a hole for positioning the protrusion of the corresponding protruding platform;
a touch panel, at least one of two opposite ends of the touch panel extending beyond the display module and located on an inner side of the corresponding protruding platform to be located at the same plane with the corresponding end plate and adjacent to the corresponding end plate to form a gap therebetween; and
a top film attached on the touch panel and end plates.

2. A touch-sensitive display apparatus claimed in claim 1, wherein the touch panel includes a base layer placed on the display module, an insulating layer attached on the base layer, and a conducting layer attached on the insulating layer.

3. A touch-sensitive display apparatus claimed in claim 2, wherein the base layer and the corresponding end plate are attached on the corresponding protruding platform by a back adhesive.

4. A touch-sensitive display apparatus claimed in claim 2, wherein the conducting layer and the top film are connected by an optical adhesive, the end plate and the top film are connected by a double-sided adhesive tape.

5. A touch-sensitive display apparatus claimed in claim 1, wherein the end plate is made of plastic.

6. A touch-sensitive display apparatus claimed in claim 1, wherein the protrusion is a receiver.

7. A touch-sensitive display apparatus claimed in claim 1, wherein the protrusion is a button.

8. A touch-sensitive display apparatus claimed in claim 2, wherein both opposite ends of the base layer extend beyond the display module and are located on inner sides of the corresponding protruding platforms to be located at the same plane with the corresponding end plates and adjacent to the corresponding end plates to form gaps therebetween.
